(19) United States
(12) Patent Application Publication
(10) Pub. No.: US 2006/0085403 A1
(43) Pub. Date: Apr. 20, 2006

(54) Method and system for multi-echelon auditing of activity of an enterprise

(76) Inventors: William E. Harrison, Cupertino, CA (US); Chris Binns-Smith, Saratoga, CA (US)

Correspondence Address: PATRICK REILLY, BOX 7218, SANTA CRUS, CA, 95061-7218, US

(21) Appl. No.: 11/015,480

(22) Filed: Dec. 18, 2004

Related U.S. Application Data
(60) Provisional application No. 60/615,057, filed on Sep. 30, 2004.

(51) Int. Cl. G06F 17/30

(52) U.S. Cl. 707/3

(57) ABSTRACT

A method, system and computer-readable media is provided that enables the synthesis in automated reporting with human generated attestations of compliance or non-compliance with regulations and laws. A first version of the claimed invention provides a method and system for employing an information technology network in an enterprise for evaluating the compliance of the activity of the information technology network with laws and regulations. The method of the first version audits computer systems, user behavior, asset behavior, and manual processes. The first version employs an information technology system to document compliance information, where the compliance information relates to the compliance of an enterprise with at least one governmental regulation

### CROSS-REFERENCES TO RELATED APPLICATIONS

This application is a Continuation to Provisional Patent Application No. 60/615,057 filed on Sep. 30, 2004, and which is incorporated herein by reference in its entirety for all purposes.

### FIELD OF THE INVENTION

The present invention relates to the creation, distribution, monitoring, and analysis of enterprise-wide executable policies. The present invention further relates to the automation and semi-automation by information technology of policy compliance auditing of automatically executed policies, in combination with the documentation of policy compliance.

### BACKGROUND OF THE INVENTION

Commercial ventures and other organizations are typically required to comply with varieties of laws and regulations in the conduct and management of their personnel, sales processes, financial documentation, real and intangible properties, and contractual relationships. In particular, the directors, officers and executives of publicly traded corporations can incur civil liabilities by failing to fully comply with minimum legal standards in the management, documentation and reporting of the operations of the enterprise.

The information technology systems that enable complex enterprise to function in effectively exploiting assets and organizational capabilities can empower managers to act without reference to legal requirements. Yet the sheer size and complexity of many modern industrial, medical, professional and social organizations make merely informing and sufficiently educating the employees responsible for managing and monitoring specific corporate activities of the concern's legal obligations relevant to their duties extremely challenging. As corporate directors, officers, and executives can be held legally liable in certain circumstance for lapses in the fulfillment of legal obligations or for intentional or unintentional illegal acts.

Organizations typically produce a written operations policy for their employees but rarely do they assess and monitor compliance against the written policy. To make matters worse, insuring that employees read the published policy is rarely verified. With the world's ever heightening regulatory and security requirements of organizations highly valuable and sensitive data, the corporate world is seeing a whole new proliferation of legal, security and privacy regulations. Country after country is legislating security and privacy laws. In the United States alone, there are a slew of complex and mandatory bodies of regulations, to include the Sarbanes-Oxley Act, GLBA, HIPAA, SB1386, etc. Failure to comply with these laws and regulations can make Directors and individuals responsible with possible jail terms. There is therefore a long felt need to provide an information technology driven method of supporting an enterprise in auditing computer systems, user behavior and manual processes.

### SUMMARY OF THE INVENTION

These and other objects will be apparent in light of the prior art and this disclosure. The present invention provides a method and system for employing an information technology network in an enterprise, the method for evaluating the compliance of the activity of the information technology network with a plurality of policies, the method auditing computer systems, user behavior, asset behavior, and manual processes. A first preferred embodiment of the method of the present invention employs an information technology system to document compliance information, where the compliance information relates to the compliance of an enterprise with at least one governmental regulation, the method comprising one or more of the following aspects:

a) providing a definition of the compliance information in an electronic media to the information technology system;

b) searching data stored within the information technology system for information satisfying the definition of compliance information;

c) reporting data found within the information technology system satisfying the definition of the compliance information via the information technology system.

d) at least partially satisfying the definition of the compliance information by means of an electronic signature;

e) acceptance of an attestation of compliance provided in an electronic record authorized by a human operator to satisfy the definition of compliance information;

f) providing an electronic message within the electronic record in satisfaction of the definition of the compliance information;

g) generating a request to a human operator to generate an electronic record as an element intended to satisfy a legal or organizational reporting or documentation requirement; and

h) providing a compliance information comprising attributes of the compliance information applied to the data associated with one or more distinguishable aspect of the enterprise;

A second preferred embodiment of the method of the present invention employs a regulatory compliance system coupled to or comprised within an information technology system, the regulatory compliance system comprising one or more of the following elements:

(a) a receiving computer that receives information from at least one element of the information technology system; and

(b) a compliance memory for storing at least one regulatory compliance requirement, wherein the compliance memory communicatively coupled with the receiving computer and enabling the receiving computer to determine when the information satisfies the least one regulatory compliance requirement.

In certain alternate preferred embodiments of the compliance memory stores a plurality of regulatory compliance requirements. In certain still alternate preferred embodiments of the present invention, the compliance memory is distributed between at least two elements of the information technology system. In certain yet alternate preferred embodiments of the present invention the at least one regulatory compliance requirement for at least one of the group of requirements including an accounting service requirement, a legal service requirement, a banking service requirement, a corporate service requirement, an insurance service requirement, a health service requirement, medical service requirement, a welfare benefit service requirement, and a corporate governance service requirement.

In certain other alternate preferred embodiments of the present invention the at least one regulatory compliance requirement presents an insurance service requirement comprising at least one of the group of insurance service requirements of a corporate directors and officers insurance, an employment practices liability insurance, and a fiduciary liability insurance.

A third alternate preferred embodiment of the method of the present invention employs an information technology system for conveying an assessment of the compliance of an enterprise with a regulatory guideline, wherein the method of conveyance comprises one of the following:

a) receiving from an element of the information technology system an electronic record authorized by a trusted party, wherein the electronic record comprises an attestation of compliance with at least a first aspect of the regulatory guideline, and the electronic record is associated with an identity of the trusted party;

b) associating the electronic record with an electronic signature;

c) receiving data generated by an automated observation of the information technology system, wherein the data comprises evidence of compliance with at least a second aspect of the regulatory guideline;

d) reporting the compliance of the enterprise with the first aspect and second aspect of the regulatory guideline via the information technology system.

e) comprising the record authorized by the trusted party is comprised within an electronic message;

f) generating a request by the information technology system for the trusted party to generate the electronic record;

g) the attestation of compliance relating to a plurality of aspects of the regulatory guideline; and

h) the regulatory guideline comprising aspects selectively applied to a distinguishable parameter of the enterprise, wherein the distinguishable parameter relates to a group of parameters that includes, but is not limited to, a financial parameter, a fiduciary parameter, a security parameter and a geographic parameter.

Other aspects of the present invention include an apparatus and a computer-readable medium configured to carry out the foregoing steps. The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 illustrates an information technology system comprising the Internet with which the work process of certain preferred embodiments of the method of the present invention may be executed and comprising a first preferred embodiment of the present invention;

FIG. 2 is a representation of a second information technology system comprising a communications network employing wireless communications devices with which the work process of certain preferred embodiments of the method of the present invention may be executed;

FIG. 3 is a flow chart of a first preferred embodiment of the method of the present invention as implemented by means of the information technology system of FIG. 1;

FIG. 4 is a flow chart of a second preferred embodiment of the method of the present invention as implemented by means of the information technology system of FIG. 1;

FIG. 5 is a flow chart of a third preferred embodiment of the method of the present invention as implemented by means of the information technology system of FIG. 1; and

FIG. 6 is a flow chart of a fourth preferred embodiment of the method of the present invention as implemented by means of the information technology system of FIG. 1.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

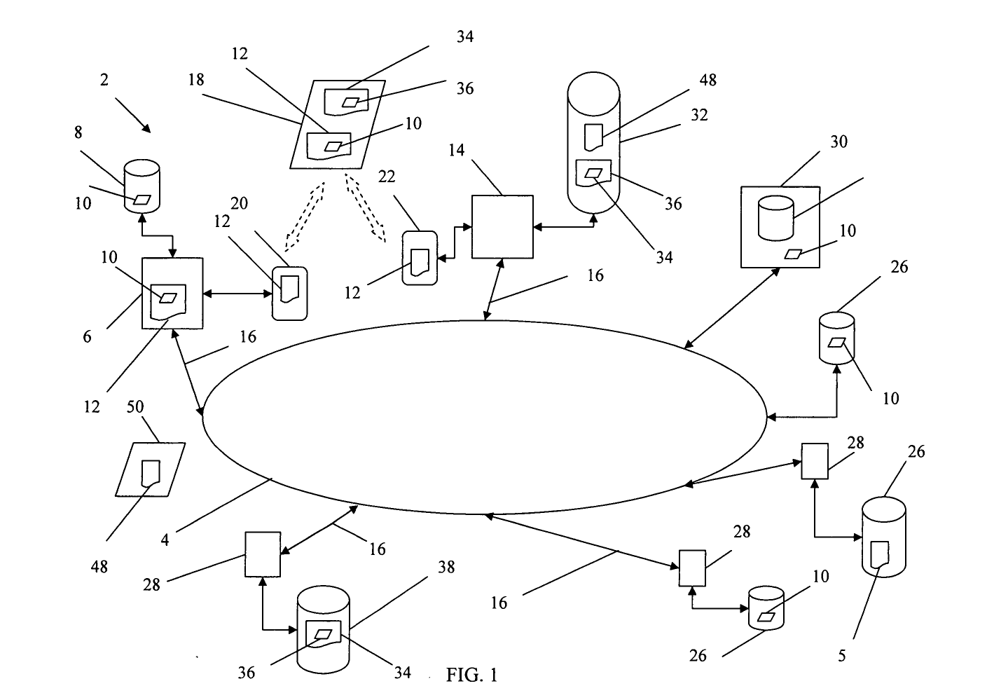

Referring now generally to the Figures and particularly to FIG. 1, FIG. 1 illustrates a first preferred embodiment of the present invention 2, being an information technology system 2, or system 2, comprising a communications network 4 with which the work process of certain preferred embodiments of the method of the present invention may be executed. A user and/or asset 5 uses a resource computer 6, having a system memory 8, to communicate with the system 2, wherein the system memory 8 stores records containing compliance data 10 and makes these records available to the network 4. The compliance data 10 is information relevant to the compliance of the enterprise to one or more government law or regulation. An asset may be an agent or other suitable software program known in the art and capable of communication with the network 2. The user or asset transmits one or more reports 12 containing compliance data 10 to an enterprise monitor workstation 14, or receiving computer 14, via an Internet connection 16 or a computer-readable medium 18, such as a floppy disk. A first reader 20 coupled with the resource computer 6 and is configured to read and/or write to the computer-readable medium 14 and store the compliance data 10. A second reader 22 is coupled to the receiving computer 14, whereby the receiving computer 14 can read the compliance data 10 from the computer-readable media, and the compliance data 10 can be transferred from the computer 6. The computer 6, enterprise monitor workstation 14, and one or more workstations 24 may be communicatively coupled with one or more readers 18. The connection 14 may be or comprise a wireless connection or a hard wire connection, such as a telephone landline or a public utility cable. The enterprise monitor workstation 14, and the computer 6, may each optionally have access, via the communications network 4 or by direct connection 16, to third-party databases 26 or database workstations 28 that contain information or databases associated with or accessible by the enterprise or the system 2. A user or asset may employ the resource computer 2 to input information for access by the receiving computer 14, or to clean, correct, validate, discard, and/or confirm the information provided by one or more third-party databases 26 by comparing this third party information with information stored in alternate locations within the system 2. The report 12 and/or third party database(s) 26 may be stored on a data storage system 30. One or more data storage systems may be communicatively coupled with the communications network 4. The receiving computer 14 comprises a compliance memory 32 for storing software code 34 describing at least one definition of a regulatory compliance requirement 36, and often a plurality of regulatory compliance requirement definitions 36 (“definitions 36”) described in software code 34. The compliance software code 34 can optionally be stored in one or more alternative memories 38 and made accessible to the receiving computer 14 via the network 4 and one or more workstations 28. Alternatively, or additionally, one or more compliance software codes 34 describing additional definitions 36 or portions of one or more can optionally be stored in one or more alternative memories 38 and/or media one or more computer-readable media 18.

The terms “computer” and “workstation” as used herein are defined to comprise an electronic computational or communications device that may communicate data or signals via a computer-readable medium, the Internet or other suitable computer networks known in the art, or may be communicatively linked with at least one computer-readable medium.

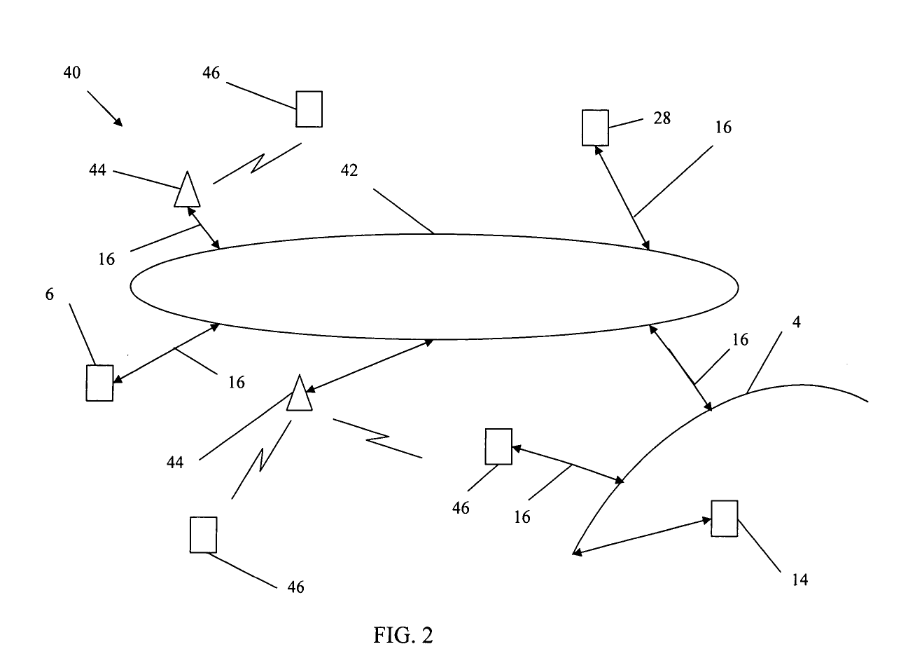

Referring now generally to the Figures and particularly to FIG. 2, FIG. 2 is a representation of a second information technology system 40 with which the method of system 2 of FIG. 1 or certain other alternate preferred embodiments of the present invention may be executed. The second system 40 comprises a communications network 42 employing antennas 44 to bi-directionally communicate with one or more wireless communications devices 46.

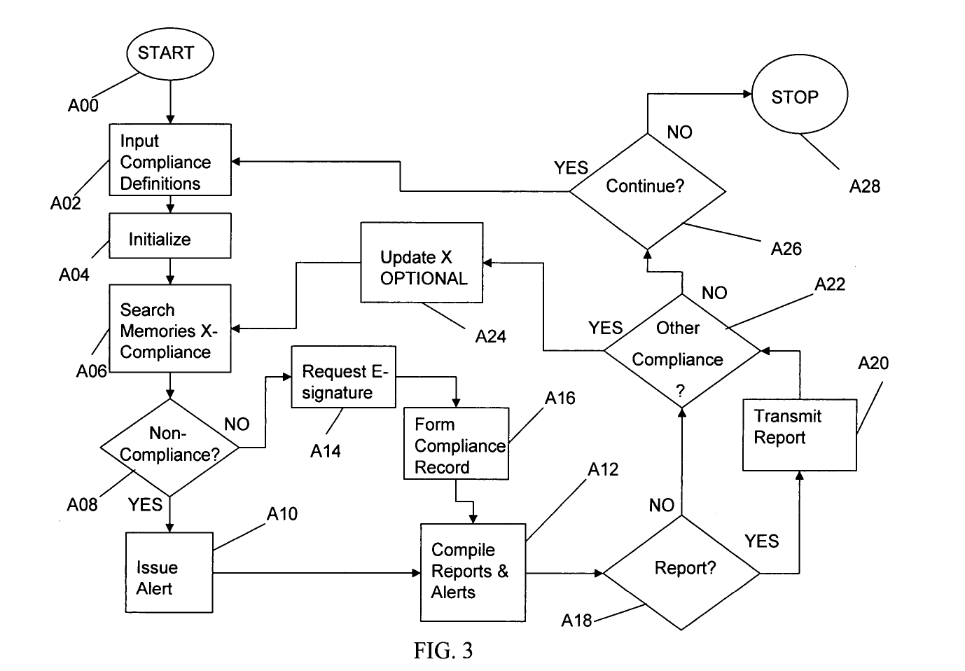

Referring now generally to the Figures and particularly to FIG. 3, FIG. 3 is a flow chart of a first preferred embodiment of the method of the present invention, or Method A, as implemented by means of the information technology system 2 of FIG. 1 and a system software program, and optionally or additionally by means of the second system 40 of FIG. 2. A system software 48 may be stored in the compliance memory 32, and/or in one or more of the system memory 8, alternate memories 38, or in other suitable memory device or system accessible to for at least partial implementation by the receiving computer 24. In step A00 Method A begins by accessing the system software for execution. In step A02 definitions 36 are read by the receiving computer 14 from the internal compliance memory 32, or from the computer-readable media 18 via the second reader 22, and/or from one or more alternative memories 38 via the network 4. It is understood that the term compliance memory us defined herein to include any memory device or system storing at least a portion of a definition of at least one definition 36 and capable of providing software code 34 to the receiving computer, wherein the software code 34 defines the at least a portion of a definition 36 in a state and mode accessible to the receiving computer 14.

In step A04 the receiving computer 14 initializes and makes accessible one or more definitions 36 used to compare with compliance data 10 in the following step A06. In step A06 the system software 48 queries the memory 8 and the network 4 for the compliance data 10. In step A08 the system software 48 compares any accessible or received compliance data 10 with the compliance requirement definitions 36 made available to the receiving computer 14. If a non-compliance to one or more definitions 48 is determined in step A08, then the system software 48 issues and alert in step A10 and proceeds on to step A12. If non-compliance is not found in step A08, then in step A14 the system software 48 requests an electronic signature from the resource computer 6, and/or other elements 26, 28, 30, 46 of the network 4 and optionally the second system 40. The term elements is defined herein to include the resource computer 6, the receiving computer 14, the third-party databases 26, the database workstations 28, data storage system 30, wireless communications devices 46, and other suitable computational devices known in the art. In step A16 the system software 48 generates a compliance record containing information selected from the information accessed, processed and generated in steps A06 and A08. In step A12 the system software 48 compiles a compliance report containing information provided in the alert of step A10 and the record of step A16, and optionally with other information available to the network 4. In A18 the system software determines to either transmit the report of step A12 via the information technology system 2. In step A20, if directed by system software 48, the report of step A12 is transmitted via the information technology system 2 to a sys admin, user or asset 5, and the system software proceeds on to step A22. If the system software 48 determines to not transmit the report of step A12, the execution of Method A proceeds directly from step A18 to step A22. In step A22 the system software 48 determines if additional access to compliance data 10 and/or comparison with definitions 36 is to be executed. If the system software 48 elects in step A22 to continue building, or attempting to build, the report of step A12, then the Method A returns to step A06, and optionally executes step A 24 prior to again implementing step A06. In optional step A22 the definitions 36 selected for use in step A08, and the compliance data accessed in step A06, may be updated to add or delete one or more definitions 36 or compliance data 10. Alternatively, when the system software 48 moves directly from step A22 to step A22, the Method A next directs that the implementation of the first preferred embodiment of the present invention shall be either paused or halted in an immediately following step A28. The system software 48 may forego the pausing or halting step of A28, and proceed onto step A02, whereby the system software may receive one or more additional or alternative definitions 36, and from step A02 on to continue a responsiveness to documenting and reporting compliance and non-compliance by the enterprise to one or more law or regulation.

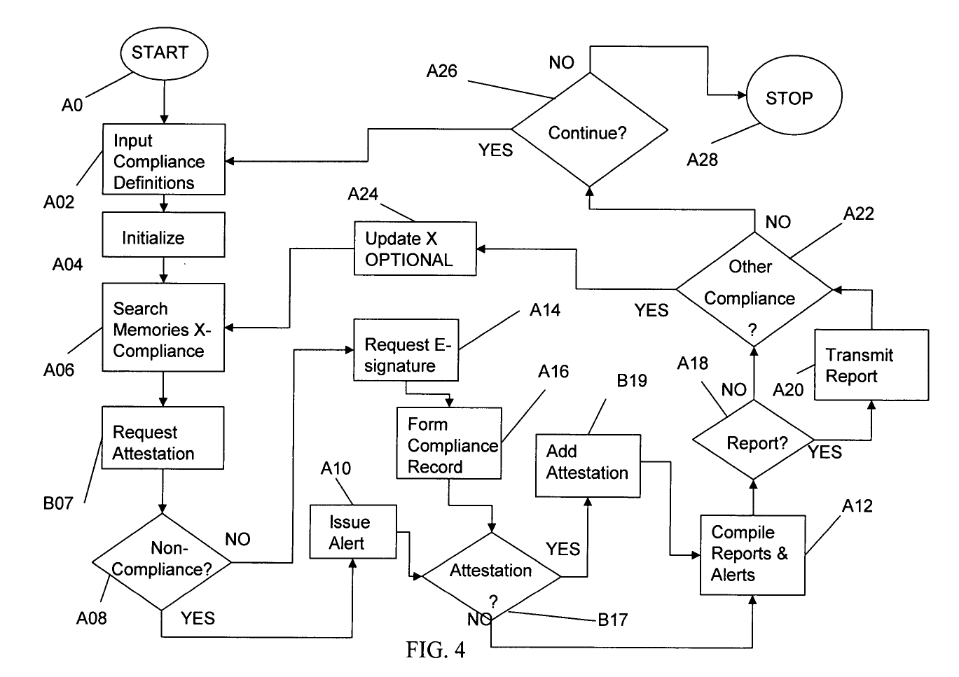

Referring now generally to the Figures and particularly to FIG. 4, FIG. 4 is a flow chart of a second preferred embodiment of the method of the present invention, or Method B, as implemented by means of the information technology system 2 of FIG. 1. Method B includes the steps A00 to A28 of Method A, and includes three additional steps of B07, B17, and B19. In step B07 the receiving computer 14 requests and/or receives and integrate one or more attestation from a user via the network 4. In step B17 the system software 48 determines if one or more attestations have been received, and, if so, adds the attestation(s) to the compliance record in step B19.

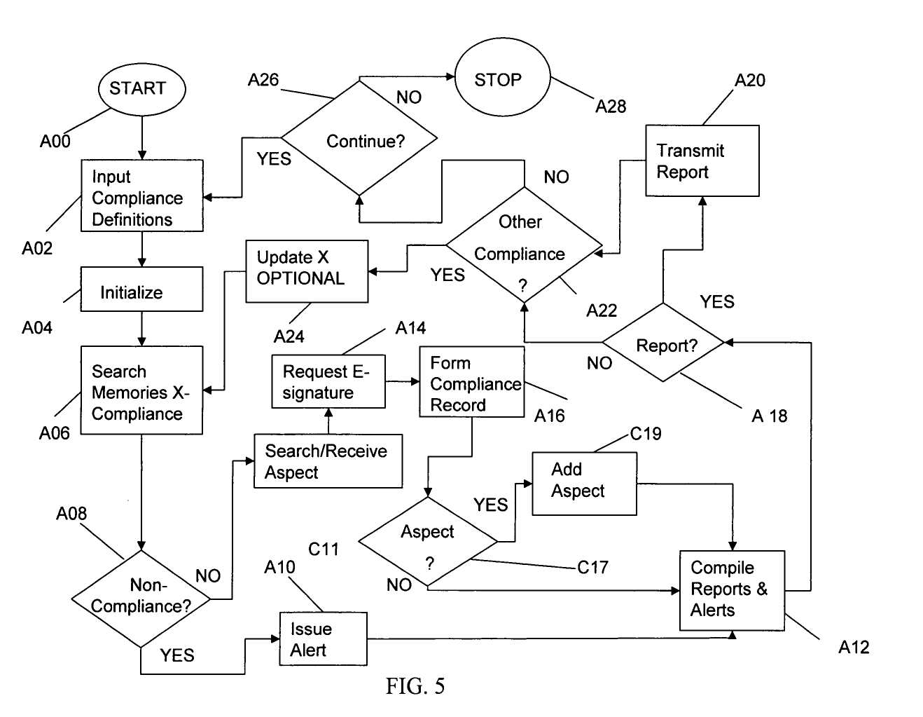

Referring now generally to the Figures and particularly to FIG. 5, FIG. 5 is a flow chart of a second preferred embodiment of the method of the present invention, or Method C, as implemented by means of the information technology system 2 of FIG. 1. Method C includes the steps A00 through A28 of Method A, and includes three additional steps of C11, C17, and C19. In step C11 the receiving computer 14 receives and integrates one or more aspect data from a user via the network 4. In step C17 the system software 48 determines if one or more aspect data have been received, and, if so, adds the one or more aspect data to the compliance record in step C19.

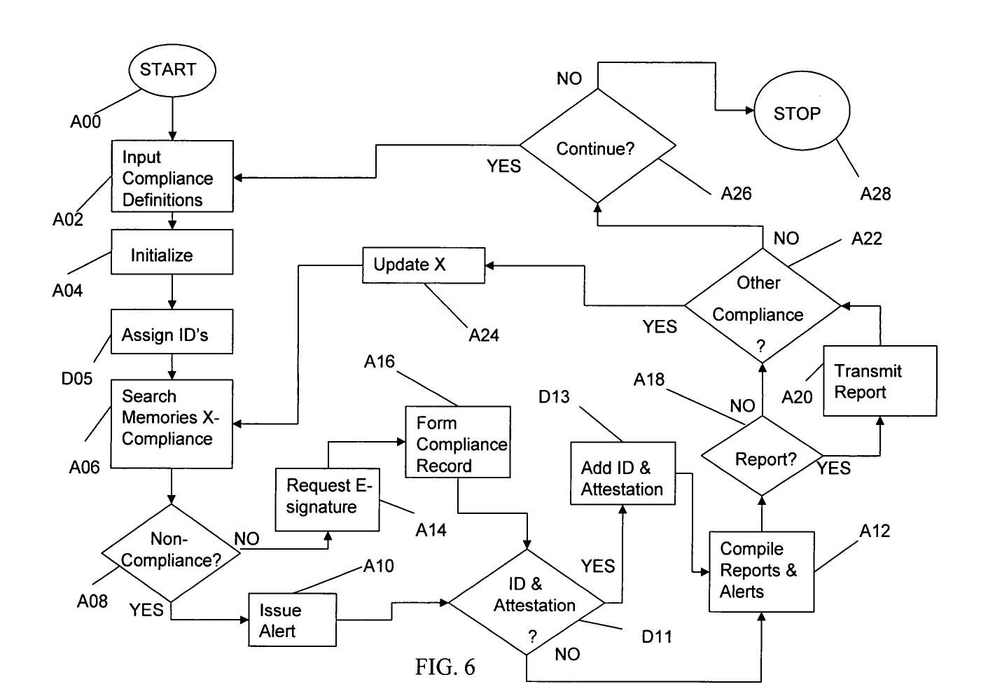

Referring now generally to the Figures and particularly to FIG. 6, FIG. 6 is a flow chart of a second preferred embodiment of the method of the present invention, or Method D, as implemented by means of the information technology system 2 of FIG. 1. Method D includes the steps A00 through A28 of Method D, and includes three additional steps of D05, D11 & D13. In step D05 the system software 48 assigns identifications (“ID's”) to users and/user groups. In step C17 the system software 48 determines if one or more ID's associated with one or more attestations have been received, and, if so, adds a recognition of one or more receipts of user or user group ID's associated with one or more attestations to the compliance record in step C19.

Referring now generally to the Figures, a computer-readable media 50 of FIG. 1 comprises a record of system software 48. System software 48 may be configured to carry out one, several or all the steps of Method A, Method B, Method C and/or Method D by means of one or more elements of the information technology system 2 and the second system 40.

The terms “computer-readable medium” and “computer-readable media” as used herein refer to any suitable medium known in the art that participates in providing instructions to the information technology system 2, the communications network 4, and/or the second system 40 for execution. Such a medium may take many forms, including but not limited to, non-volatile media, volatile media, and transmission media. Non-volatile media includes, for example, optical or magnetic disks, such as storage device 10. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

Those skilled in the art will appreciate that various adaptations and modifications of the aforementioned described preferred embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

We claim:

1. In an information technology system, a method for documenting compliance information, the compliance information relating to compliance of an enterprise with at least one governmental regulation, the method comprising:
a) providing a definition of the compliance information in an electronic media to the information technology system;
b) searching data stored within the information technology system for compliance data satisfying the definition of compliance information; and
c) reporting compliance data found within the technology system satisfying the definition of the compliance information via the information technology system.

2. The method of claim 1, wherein the definition of the compliance information is at least partially satisfied by an electronic signature.

3. The method of claim 1, wherein the information technology system accepts compliance data comprised within an attestation of compliance provided in an electronic record and authorized by a human operator, wherein the compliance data at least partially satisfies the definition of compliance information.

4. The method of claim 3, wherein the electronic record comprises an electronic message.

5. The method of claim 3, wherein the information technology system requests the human operator to generate the electronic record.

6. The method of claim 5, wherein the electronic record comprises an electronic signature.

7. The method of claim 5, wherein the electronic record comprises an electronic message.

8. The method of claim 1, wherein the definition of compliance information comprises attributes of the compliance information applied to the compliance data associated with a distinguishable aspect of the enterprise.

9. In an information technology system of an enterprise, a regulatory compliance system comprising:
(a) a receiving computer that receives compliance data from at least one element of the information technology system;
(b) a compliance memory for storing at least one regulatory compliance requirement; and
(c) the compliance memory communicatively coupled with the receiving computer and enabling the receiving computer to determine when the information satisfies the least one regulatory compliance requirement.

10. The system of claim 9, wherein the compliance memory stores a plurality of regulatory compliance requirements.

11. The system of claim 10, wherein the compliance memory is distributed between at least two elements of the information technology system and accessible to the receiving computer.

12. The system of claim 9, wherein the at least one regulatory compliance requirement for at least one of the group of requirements including an accounting service requirement, a legal service requirement, a banking service requirement, a corporate service requirement, an insurance service requirement, a health service requirement, medical service requirement, a welfare benefit service requirement, and a corporate governance service requirement.

13. The system of claim 12, wherein the insurance service requirement comprises at least one of the group of insurance service requirements of a corporate directors and officers insurance, an employment practices liability insurance, and a fiduciary liability insurance.

14. In an information technology system, a method for conveying an assessment of the compliance of an enterprise with a regulatory guideline, the method comprising:
a. receiving from an element of the information technology system an electronic record authorized by a trusted party, wherein the electronic record comprises an attestation of compliance with at least a first aspect of the regulatory guideline, and the electronic record is associated with an identity of the trusted party;
b. receiving compliance data generated by an automated observation of the information technology system, wherein the compliance data comprises evidence of compliance with at least a second aspect of the regulatory guideline; and
c. reporting the compliance of the enterprise with the first aspect and second aspect of the regulatory guideline via the information technology system.

15. The method of claim 14, wherein the electronic record authorized by the trusted party is associated with an electronic signature.

16. The method of claim 14, wherein the electronic record authorized by the trusted party is comprised within an electronic message.

17. The method of claim 14, wherein the information technology system requests the trusted party to generate the electronic record.

18. The method of claim 14, wherein the attestation of compliance relates to a plurality of aspects of the regulatory guideline.

19. The method of claim 14, wherein the regulatory guideline comprises aspects selectively applied to a distinguishable parameter of the enterprise.

20. The method of claim 19, wherein the distinguishable parameter relates to a group of parameters including a financial parameter, a fiduciary parameter, a security parameter and a geographic parameter.

21. A system having a computer-readable medium and a computer network, wherein the computer-readable medium carrying one or more sequences of one or more instructions for buffering data, wherein the execution of the one or more sequences of the one or more instructions by one or more processors, causes the one or more processors to perform the method comprising:
a. receiving from an element of the information technology system an electronic record authorized by a trusted party, wherein the electronic record comprises an attestation of compliance with at least a first aspect of the regulatory guideline, and the electronic record is associated with an identity of the trusted party;
b. receiving data generated by an automated observation of the information technology system, wherein the data comprises evidence of compliance with at least a second aspect of the regulatory guideline; and
c. reporting the compliance of the enterprise with the first aspect and second aspect of the regulatory guideline via the information technology system, whereby the computer-readable medium may provide one or more sequences of one or more instructions supportive of documenting attestations and automated observations related to one or more foci of one or more regulatory guidelines.
